(19) United States
(12) Patent Application Publication
(10) Pub. No.: US 2008/0194294 A1
(43) Pub. Date: Aug. 14, 2008

(54) Telecommunication Device and Baseband Processor For this Device

(75) Inventor: David Ryon, Roemen sur Sarthe (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/629,767

(22) PCT Filed: Jun. 8, 2005
(86) PCT No.: PCT/IB05/51871

§ 371 Date: Nov. 5, 2007

(30) Foreign Application Priority Data
Jun. 14, 2004 (EP) 04300374.8

(51) Int. Cl. H04B 1/38

(52) U.S. Cl. 455/558

(57) ABSTRACT

The telecommunication device (6) comprises: a housing (12), a Subscriber Identity Module (SIM) card holder (28) within the housing, and a printed circuit board (14) having a baseband processor and a first radio transceiver (16) to receive and transmit a plurality of telephone calls, a second radio transceiver (30) adapted to communicate with a SIM card inserted into the SIM card holder using wireless communication.

### FIELD OF THE INVENTION

The present invention relates to a telecommunication device and a baseband processor for this device

A known telecommunication device comprises:
a housing,
a Subscriber Identity Module (SIM) card holder within the housing, and
a printed circuit board having a baseband processor and a radio transceiver to receive and transmit a plurality of telephone calls.

Typically, printed circuit boards of telecommunication devices also have a mechanism having six connecting leads establishing a wired communication with a SIM card inserted in the card holder. The reliability of the wired communication depends on the quality of the electrical contacts between the six connecting leads and the corresponding connection pad on the SIM card.

Bad electrical contacts may happen due to mechanical stresses on the card holder. Bad electrical contacts, in turn, cause network losses.

### SUMMARY OF THE INVENTION

Accordingly, it is an object of the invention to provide a more reliable telecommunication device.

With the above and other objects in view, there is provided in accordance with the invention, a telecommunication device wherein the printed circuit board comprises a second radio transceiver adapted to communicate with a SIM card, which is inserted into a card holder, using wireless communication.

In the above telecommunication device, the mechanism having connecting leads establishing a wired communication with the SIM card is replaced by the second radio transceiver. As a result, a wireless communication replaces the wired communication. The wireless communication is less sensitive to mechanical stresses on the card holder. Thus, the reliability of the data exchange between the printed circuit board and the SIM card inserted into the card holder is improved.

The device according to the invention wherein:
the baseband processor is an integrated circuit comprising at least one electronic chip within a protective package, and
the second transceiver is located within the same protective package,
   provides more space on the printed circuit board because the increase in size of the baseband processor due to the second transceiver is smaller than the size of the mechanism having connecting leads for a wired communication with the SIM card.

The device according to the invention, comprising:
a cover (54) to protect at least part of the printed circuit board from radiated electrical fields, and
an antenna (32) connected to the second transceiver for reading data from a SIM card inserted into the card holder, the antenna being positioned on the shielding cover,
   provides more space on the printed circuit board as well.

The device according to the invention, wherein the SIM card holder is secured to an inner surface of the housing located in front of the antenna, improves the reliability of the communication between the printed circuit board and the SIM card.

The device according to the invention, wherein the second transceiver is adapted to communicate using a radio frequency of 13.56 MHz, and wherein this second transceiver is further adapted to communicate with other devices located outside the housing, greatly reduces manufacturing costs.

The invention also relates to a baseband processor used in the telecommunication device.

These and other aspects of the invention will be apparent from the following description, drawings and claims.

### BRIEF DESCRIPTION OF THE DRAWINGS

FIG. 1 is a schematic diagram of a radiotelephone system comprising a telecommunication device,

FIG. 2 is a cross-section of the telecommunication device of FIG. 1; and

FIG. 3 is a flowchart of a method for operating the telecommunication device of FIG. 1.

### DESCRIPTION OF THE PREFERRED EMBODIMENTS

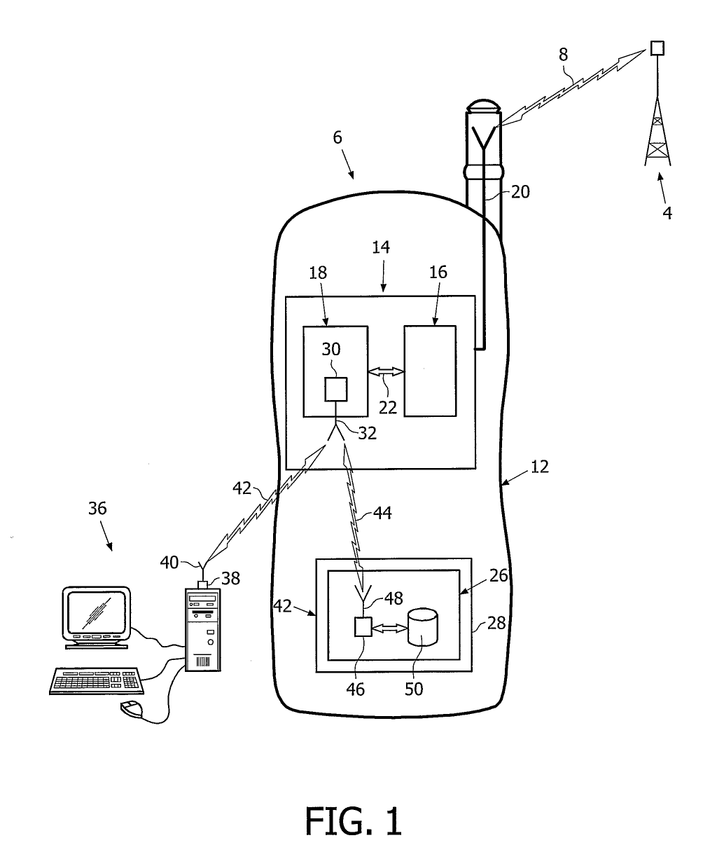

FIG. 1 shows a radiotelephone system 2 comprising a network base station 4 and a radio telecommunication device. For exemplary purposes, the radio telecommunication device is a radio cellular mobile phone 6. Phone 6 communicates with a base station 4 using radio signals 8.

Base station 4 includes an emitter and a receiver to send and receive radio signals 8 to and from phone 6.

Phone 6 comprises a housing 12 and a printed circuit board 14 having a radio frequency transceiver 16 and a baseband processor 18 to receive or transmit radio signals 8. Printed circuit board 14 is housed within housing 12. Housing 12 has a door that a user opens to insert a SIM card in phone 6.

Transceiver 16 is connected to an antenna 20 to receive or transmit radio signals 8.

Transceiver 16 converts a received radio signal into a baseband signal and vice-versa. In other words, the main task of transceiver 16 is to remove a carrier from the radio signal or to add such a carrier to a baseband signal. Baseband signals are exchanged between processor 18 and subsystem 16 through a line 22 that connects transceiver 16 to processor 18.

Processor 18 controls every piece of equipment of phone 6. In particular, processor 18 is adapted to read data from a SIM card 26 inserted into a card holder 28. Card holder 28 is located within housing 12.

Processor 18 is an integrated circuit comprising one or more electronic chips housed within a protective package. In the present embodiment, processor 18 also comprises a radio transceiver 30 housed within its protective package and connected to an antenna 32. Transceiver 30 is adapted to establish a wireless communication link with another device using a NFC (Near Field Communication) technique. The NFC technique is well-known and inexpensive. It is based on radio frequencies at 13.56 MHz that allow for a wireless communication at a distance of less than 10 cm with a data exchange rate up to 1 Mbit.

In FIG. 1, a computer 36 represents a device that communicates with phone 6 using NFC technique. To do so, computer 36 includes a radio transceiver 38 connected to an antenna 40 for establishing a wireless communication link 42 with transceiver 30.

Transceiver 30 simultaneously establishes several wireless communication links with one or more devices.

SIM card 26 is a passive data carrier that communicates with transceiver 30 through a wireless communication link 44. For example, card 26 is a contactless smart card comprising a radio transceiver 46 connected to an antenna 48, which are both incorporated in a plastic card. Card 26 can be inserted into or removed from card holder 28.

As usual, the SIM card also comprises a memory 50 for storing useful data for operating phone 6, such as telephone numbers and the like. Memory 50 is linked to transceiver 26.

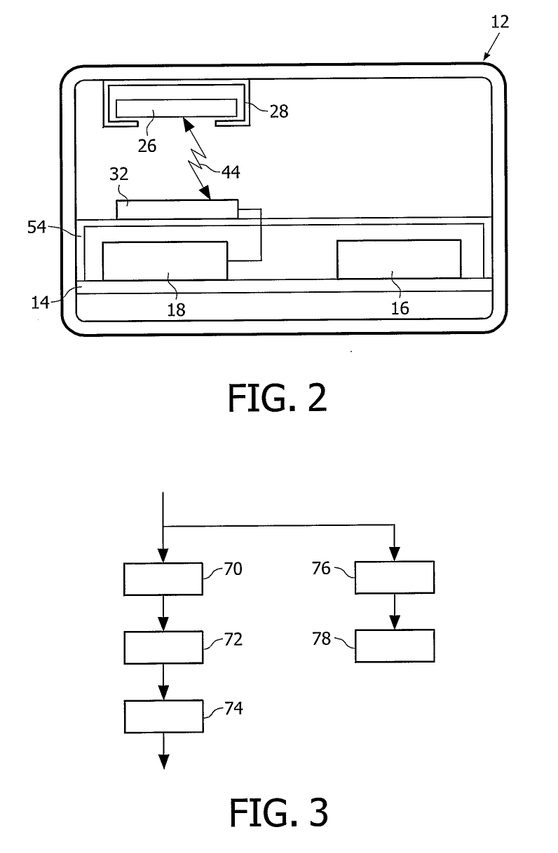

In FIG. 1, for simplicity, card holder 28 does not overlap board 14. FIG. 2 shows, in a cross-sectional view, the location of card holder 28 in relation to the location of board 14. In the cross-sectional view, board 14 is horizontal and located at a bottom part of housing 12. In FIG. 2, the elements of phone 6 have the same reference as in FIG. 1.

As shown in FIG. 2, a shielding cover 54 is fixed on top of board 14. Cover 54 is intended to protect board 14 from external radiated electromagnetic fields. For example, at least part of cover 54 is located on top of processor 18 to protect this processor. Antenna 32 is fixed on top of cover 54 to save space on board 14. For example, antenna 32 is located on a surface of cover 54, which is above processor 18.

Card holder 28 is secured within housing 12 to minimize the distance between antenna 32 and antenna 48 of card 26. This increases the reliability of link 44. Here, card holder 28 is located above antenna 32.

The operation of phone 6 will now be described with reference to FIG. 3.

Initially, in step 70, the user of phone 6 opens housing 12 and inserts card 26 in card holder 28.

Then, in step 72, phone 6 is powered and transceiver 30 establishes link 44 with card 26. Once link 44 has been established, in a step 74, processor 18 reads data from card 26 via link 44 in a contactless manner. For example, transceiver 30 transmits a modulated high-frequency signal having a frequency of 13.56 MHz. In response, card 26 transmits the required data via link 44 by means of another modulation.

Simultaneously or thereafter, in a parallel step 76, transceiver 30 establishes link 42 to communicate with computer 36. In step 78, once link 42 has been established, data are exchanged between computer 36 and processor 18 via link 42.

1. A telecommunication device comprising:
a housing
a Subscriber Identity Module card holder within the housing, and
a printed circuit board having a baseband processor and a first radio transceiver to receive and transmit a plurality of telephone calls, wherein the printed circuit board also comprises a second radio transceiver adapted to communicate with a SIM card inserted into the SIM card holder using wireless communication.

2. The device of claim 1, wherein:
the baseband processor is an integrated circuit comprising at least one electronic chip in a protective package, and
the second transceiver is located in the same protective package.

3. The device of claim 2, wherein the device comprises:
a cover to protect at least part of the printed circuit board from radiated electrical fields, and
an antenna connected to the second transceiver for reading data from a SIM card inserted into the card holder, the antenna being positioned on the shielding cover.

4. The device of claim 3, wherein the SIM card holder is secured to an inner surface of the housing located in front of the antenna.

5. The device according to claim 1, wherein the second transceiver is adapted to communicate using a radio frequency of 13.56 MHz.

6. The device according to claim 1 wherein the second transceiver is further adapted to communicate with other devices located outside the housing.

7. The device according to claim 1, wherein the device is a mobile phone.

8. A baseband processor for a telecommunication device according to claim 2, wherein the baseband processor is an integrated circuit comprising at least one electronic chip in a protective package, and the second transceiver is located in the same protective package.
